(19) United States
(12) Patent Application Publication
(10) Pub. No.: US 2006/0133092 A1
(43) Pub. Date: Jun. 22, 2006

(54) Backlight module having light diffusing device

(75) Inventor: Chao-Shih Yen, Taitung City (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 11/124,090

(22) Filed: May 9, 2005

(30) Foreign Application Priority Data
Dec. 17, 2004 (TW) 093220372

(51) Int. Cl. F21V 5/00; F21V 7/00

(52) U.S. Cl. 362/330; 362/328; 362/308

(57) ABSTRACT

A backlight module having a light diffusing device is disclosed, comprising a frame, a reflecting plate, a top plate, at least one light source, and at least one diffusing plate, in which the reflecting plate having an upper surface is mounted at a bottom side of the frame and the top plate is mounted on a top side of the frame to space a predetermined distance from the reflecting plate. The light source is mounted on the upper surface of the reflecting plate. The light diffusing plate is mounted on the lower surface of the top plate, and the light diffusing plate is corresponding to the light source. The light diffusing plate having an un-uniform thickness inversely proportional to the distance between the light source and the top plate.

### BACKGROUND OF THE INVENTION

1. Field of the Invention

The present invention relates to a backlight module having a light diffusing device and, more particularly, to a device suitable for a direct-type backlight module to uniformly diffuse light rays emanating from a light source.

2. Description of Related Art

In general, a large-sized liquid crystal panel uses a direct-type backlight module to generate light, the direct-type backlight module including a lamp (a light source), a light diffusing plate, a reflecting plate and a frame. The luminance distribution of the backlight module, whether it is uniform or not, depends on the design of the components of the aforesaid direct-type backlight module.

Traditionally, to provide the backlight module with a uniform luminance distribution of light rays, a component such as the light diffusing plate is subject to a dim process, or alternatively, a diffuser film is disposed on the light diffusing plate. However, it causes not only the luminance of the whole backlight module to be reduced but also damages to the diffuser film as a result of heat generated by the lamp. Hence, the distance between the lamp and the light diffusing plate has to be increased. As a result, the thickness of the whole backlight module is increased. Furthermore, a change in the distance between the lamp and the light diffusing plate causes the backlight module to have a non-uniform luminance distribution, impairing the quality of the backlight module.

In addition, another known method for eliminating the aforesaid problems is to have the light diffusing plate screen-printed directly so as to form a plurality of dotted patterns for shielding light on the surface of the light diffusing plate. Thus, the problem of non-uniform luminance distribution caused by the change in the distance between the lamp and the light diffusing plate is solved. However, this still reduces the luminance of the whole backlight module, and needs to be improved.

Therefore, it is desirable to provide an improved backlight module having a light diffusing device to mitigate and/or obviate the aforementioned problems.

### SUMMARY OF THE INVENTION

Accordingly, the present invention provides a backlight module having a light diffusing device, comprising a frame, a reflecting plate, a top plate, at least one light source and at least one light diffusing plate, in which the reflecting plate having an upper surface is mounted on a bottom side of the frame and the top plate having a lower surface is mounted on a top side of the frame to space a predetermined distance from the reflecting plate.

In addition, the at least one light source is mounted on the upper surface of the reflecting plate. The at least one light diffusing plate is mounted on the lower surface of the top plate, corresponding to the at least one light source. The aforesaid light diffusing plate has an un-uniform thickness inversely proportional to the distance between the at least one light source and the top plate.

Thus, the primary object of the present invention is to provide a backlight module having a light diffusing device capable of eliminating the problem of non-uniform luminance distribution caused by the change in the distance between the light source and the top plate with the design of the light diffusing plate having a thickness inversely proportional to the distance between the light source and the top plate. The luminance provided by the backlight module is uniform without impairing the luminance of the backlight module. Also, the distance between the light source and the top plate is shortened. Hence, the thickness of the whole backlight module is reduced to achieve a light-weight, thin and low-profile design.

The external wall of the light diffusing plate of the present invention is either a continuous curve such as a circle and an ellipse in cross-section or a non-continuous segment such as a polygon in cross-section. Furthermore, the light diffusing plate is made of translucent material while the top sheet is made of transparent material; or conversely, the light diffusing plate is made of transparent material while the top sheet is made of translucent material to achieve the same result. The light diffusing plate is made of a thermosetting material such as transparent rubber, silica gel, epoxy resin, phenolic (PMC) resin, melamine (MMC) resin, unsaturated polyester (UPC) resin, polyamide resin and polyimide resin; a thermoplastic material such as polythene (PE) resin, polyvinyl chloride (PVC) resin, polystyrene (PP) resin, polymethyl methacrylate (PMMA) resin, polycarbonate (PC) resin and polybutylene terephthalate (PBT) resin; or a glass. A transparent glass is the most preferable for its heat-resistant capability so as to shorten the predetermined distance between the light diffusing plate and the top plate and also reduce the thickness of the whole backlight module. The distance between the light source and the top plate can be shortened so as to reduce the thickness of the whole backlight module and achieve a light-weight, thin and low-profile design.

The aforesaid light diffusing plate can be adhered to the lower surface of the top plate.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a first preferred embodiment of the present invention.

FIG. 2 is an enlarged cross-sectional view of the first preferred embodiment of the present invention.

FIG. 3 is an enlarged cross-sectional view of the first preferred embodiment of the present invention.

FIG. 4 is an enlarged cross-sectional view of a second preferred embodiment of the present invention.

### DETAILED DESCRIPTION OF THE PREFERRED EMBODIMENT

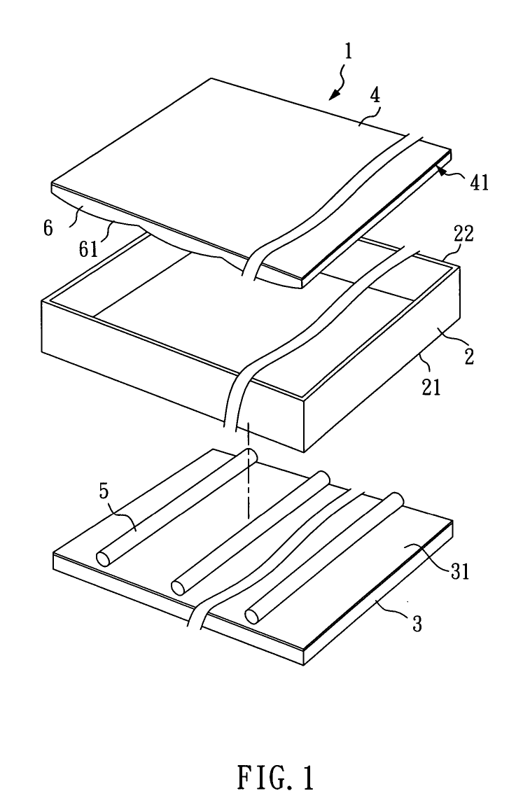

Referring to FIG. 1 that illustrates an exploded perspective view of the first preferred embodiment of the present invention, a backlight module 1 having a light diffusing device is shown. The backlight module 1 comprises a frame 2, a reflecting plate 3, a top plate 4, a plurality of light sources 5, and a light diffusing plate 6. In FIG. 1, three light sources 5 are disclosed.

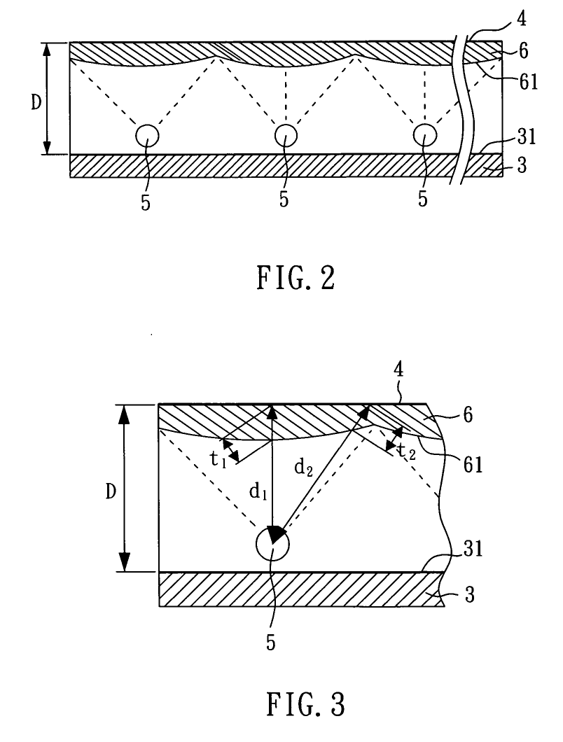

Referring to both FIG. 1 and FIG. 2 that illustrates a cross-sectional view of the first preferred embodiment of the present invention, the reflecting plate 3 having an upper surface 31 is mounted on a bottom side 21 of the frame 2, and also, the top plate 4 is mounted on a top side 22 of the frame 2. Thus, a cavity is formed among the frame 2, the reflecting plate 3 and the top plate 4 spaced at a predetermined distance D from the reflecting plate 3. The top plate 4 has a lower surface 41.

In addition, the aforesaid light sources 5 are mounted on the upper surface 31 of the reflecting plate 3. In this embodiment, each of the light sources 5 is a lamp.

Moreover, the light diffusing plate 6 is mounted on the lower surface 41 of the top plate 4, corresponding to the light sources 5. In this embodiment, the light sources 5 are lamps respectively, and also, the light diffusing plate 6 is disposed between the light sources 5 and the top plate 4.

Referring to FIG. 1, FIG. 2 and FIG. 3 that illustrates an enlarged cross-sectional view of the first embodiment of the present invention, the light diffusing plate 6 is made of a translucent material while the top plate 4 is made of a transparent material in this embodiment. Also, the light diffusing plate 6 has an un-uniform thicknesses t1, t2 inversely proportional to the distances d1, d2 between the light sources 5 and the top plate 4. Hence, the light sources 5 are diffused uniformly. In other words, light rays emanating from the light sources 5 are uniformly shed on the top plate 4 by the design where the thicknesses t1, t2 of the light diffusing plate 6 are inversely proportional to the distances d1, d2 between the light sources 5 and the top plate 4.

In the aforesaid design, the external wall 61 of the light diffusing plate 6 is a continuous parabolic curve in cross-section, and the light diffusing plate 6 is adhered to the lower surface 41 of the top plate 4.

Hence, the aforesaid arrangement, along with the designs of the light diffusing plate 6 and the thicknesses t1, t2 of the light diffusing plate 6 to be inversely proportional to the distances d1, d2 between the light sources 5 and the top plate 4, can eliminate the problem of non-uniform luminance distribution caused by a change in the distances between the light sources 5 and the top plate 4. The backlight module 1 can provide a uniform luminance distribution without impairing the luminance thereof.

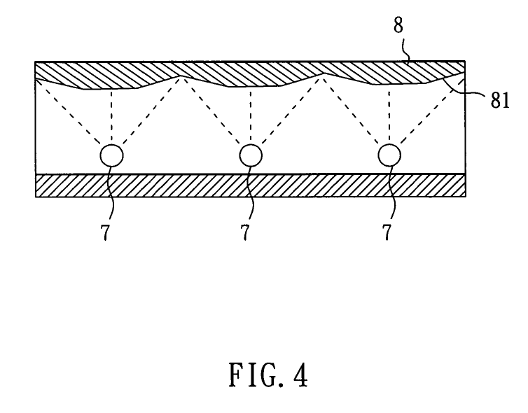

Referring now to FIG. 4 that illustrates an enlarged cross-sectional view of a second preferred embodiment of the present invention, the primary structure of this embodiment is the same as the above-mentioned first embodiment, except that the external wall 81 of a light diffusing plate 8 is a non-continuous polygonal segment in cross-section. Even so, this design is capable of providing a uniform luminance distribution of light sources 7, and also, the advantages achieved by the aforesaid embodiments remain in this embodiment.

It is inferable from the above that the external wall 61, 81 of the light diffusing plate 6, 8 can be formed in various shapes. For example, the cross-section of the external wall is shaped as a circle, an ellipse or another continuous curve; or alternatively, the cross-section of the external wall is shaped as a non-continuous polygonal segment.

On the other hand, referring to FIG. 1, FIG. 2 and FIG. 3 again, in the first embodiment, the top plate 4 is made of a transparent glass having heat-resistant capability so as to not only shorten the predetermined distance D between the top plate 4 and the reflecting plate 3 but also reduce the thickness of the whole backlight module 1. Nevertheless, the top plate 4 can be made of a transparent rubber, silica gel or any other transparent material; or conversely, the light diffusing plate 6 is made of a transparent material while the top plate 4 is made of a translucent material. For example, the light diffusing plate 6 is made of a transparent glass so as to not only shorten the predetermined distance D between the top plate 4 and the reflecting plate 3 but also reduce the thickness of the whole backlight module 1.

Although the present invention has been explained in relation to its preferred embodiments, it is to be understood that many other possible modifications and variations can be made without departing from the spirit and scope of the invention as hereinafter claimed.

What is claimed is:

1. A backlight module having a light diffusing device, comprising:
a frame;
a reflecting plate mounted on a bottom side of said frame, said reflecting plate having an upper surface;
a top plate mounted on a top side of said frame, said top plate having a lower surface, and said top plate spaced a predetermined distance from said reflecting plate;
at least one light source mounted on said upper surface of said reflecting plate; and
at least one light diffusing plate mounted on said lower surface of said top plate, said at least one light diffusing plate is corresponding to said at least one light source;
wherein said at least one light diffusing plate has an un-uniform thickness which is inversely proportional to the distance between said at least one light source and said top plate.

2. The backlight module having a light diffusing device of claim 1, wherein said at least one light diffusing plate comprises a lower wall of continuous curve in cross-section.

3. The backlight module having a light diffusing device of claim 2, wherein the lower wall of said at least one light diffusing plate has a parabolic curve in cross-section.

4. The backlight module having a light diffusing device of claim 1, wherein said at least one light diffusing plate comprises a lower wall of non-continuous segment in cross-section.

5. The backlight module having a light diffusing device of claim 1, wherein said at least one light diffusing plate is made of translucent material while said top plate is made of transparent material.

6. The backlight module having a light diffusing device of claim 1, wherein said at least one light diffusing plate is adhered to said lower surface of said top plate.
